(19) United States
(12) Patent Application Publication
(10) Pub. No.: US 2014/0166362 A1
(43) Pub. Date: Jun. 19, 2014

(54) Implement Pose Control System and Method

(71) Applicant: CATERPILLAR INC., Peoria, IL (US)

(72) Inventors: Todd Rowland Farmer, Dana Point, CA (US); Christopher Erik Bright, Raleigh, NC (US)

(73) Assignee: CATERPILLAR INC., Peoria, IL (US)

(21) Appl. No.: 13/714,985

(22) Filed: Dec. 14, 2012

(51) Int. Cl. E21B 44/00; G06F 17/00

(52) U.S. Cl. CPC E21B 44/00; G06F 17/00
USPC 175/24; 60/327; 60/420; 701/50

(57) ABSTRACT

An implement pose control system and method is provided for a machine. The system and method include determining an actual implement pose having a first actual angle component relative to the first implement rotational axis and a second actual angle component relative to the second implement rotational axis. A desired implement pose may be determined that has first and second desired angle components relative to the first and second implement rotational axes. First and second axis errors may be determined, and the first and second actuators may be automatically operated in response to the error signals.

### TECHNICAL FIELD

The present disclosure generally relates to systems and methods for controlling implements, and more particularly to automated systems and methods of placing implements provided on machines in predetermined poses.

### BACKGROUND

Machines such as, for example, backhoes, excavators, dozers, loaders, motor graders, and other types of heavy equipment use multiple actuators supplied with hydraulic fluid from an engine-driven pump to accomplish a variety of tasks. The actuators (e.g., hydraulic cylinders and motors) are used to move linkage members and implements on the machines including, for example, a boom, a stick, and a bucket. An operator controls movements of the actuators by moving one or more input devices, for example joysticks. Joystick movement manipulates a control valve associated with each actuator to control movement of the boom and stick to position or orient the bucket to perform a task. Typical operator control permits individual controlled movement of each linkage member with a corresponding operator input device, for example, along a specific input device axis. That is, each linkage (e.g. boom, stick, and bucket) is controlled by movement along a specific input device axis of one or more joysticks.

Typical operator control suffers several drawbacks due to the complex coordination required to maneuver the implement, especially when the implement is attached to a linkage system that allows implement movement about three or more degrees of freedom. For example, when moving an implement along a predefined trajectory, the operator must continuously manipulate the joysticks to complete the task. As a result, some tasks may require a high level of skill that must be learned through experience. Even experienced operators may lack the necessary skill to precisely complete complex tasks. Further, operators of all skill levels may become inefficient due to fatigue or boredom when completing routine or repetitive tasks.

In one example of a system for controlling a machine implement, U.S. Pat. No. 6,968,264 (the '264 patent) issued to Cripps on Nov. 22, 2005 discloses a machine including a mechanical arm having a first segment, a second segment, and a tool segment. Each segment pivots about a joint and is moved by one or more actuators. The '264 patent further discloses a system for controlling the mechanical arm by defining a planned path and automatically correcting an actual path of the mechanical arm when it is detected that the actual path differs from the planned path. For example, automatic correction may overcome inefficient movement by the operator due to operator fatigue or sloppy operating commands. The planned path may be stored in a library of planned paths and may be selected based one or more of the following factors: the geometry of the mechanical arm, the planned work task of the mechanical arm, the identity of the machine to which the mechanical arm is operably connected, and an optimal or preferential path of a skilled experienced operator of the machine or mechanical arm. While the machine of the '264 patent may help ensure the mechanical arm follows a particular path, the '264 patent may be limited because it fails to simplify typical complex operator input controls used to position the mechanical arm, and may be limited to use in a selected number of predetermined implement paths.

### SUMMARY OF THE DISCLOSURE

In accordance with one aspect of the disclosure, a method is provided of automatically controlling a pose of an implement on a machine. The machine may include a first actuator configured to rotate the implement about a first implement rotational axis and a second actuator configure to rotate the implement about a second implement rotational axis substantially perpendicular to the first implement rotational axis. The method may include determining an actual implement pose having a first actual angle component relative to the first implement rotational axis and a second actual angle component relative to the second implement rotational axis. A desired implement pose may be determined that has a first desired angle component relative to the first implement rotational axis and a second desired angle component relative to the second implement rotational axis. A first axis error may be determined that is indicative of a difference between the first desired angle component and the first actual angle component, and a second axis error may be determined that is indicative of a difference between the second desired angle component and the second actual angle component. The method may further include automatically operating the first actuator in response to the first axis error, and automatically operating the second actuator in response to the second axis error.

In another aspect of the disclosure that may be combined with any of these aspects, a system is provided for automatically controlling a pose of an implement provided on a machine. The system may include a first actuator operably coupled to the implement and configured to rotate the implement relative to a first implement rotational axis, a second actuator operably coupled to the implement and configured to rotate the implement relative to a second implement rotational axis substantially perpendicular to the first implement rotational axis, and a sensor configured to determine an actual pose of the implement and generate an actual pose signal, the actual pose signal including a first actual angle component relative to the first implement rotational axis and a second actual angle component relative to the second implement rotational axis. A controller may be operably coupled to the first actuator, second actuator, and sensor, and configured to determine a desired implement pose having a first desired angle component relative to the first implement rotational axis and a second desired angle component relative to the second implement rotational axis, determine a first axis error indicative of a difference between the first desired angle component and the first actual angle component, and determine a second axis error indicative of a difference between the second desired angle component and the second actual angle component. The controller may further be configured to automatically operate the first actuator in response to the first axis error, and automatically operate the second actuator in response to the second axis error

In another aspect of the disclosure that may be combined with any of these aspects, a machine may include a frame, a ground-engaging member coupled to the frame, an operator interface supported by the frame, an arm pivotably coupled to the frame, and an implement pivotably coupled to the arm by a linkage. A first actuator may be operably coupled to the linkage and configured to rotate the implement relative to a first implement rotational axis, and a second actuator may be operably coupled to the implement and configured to rotate the implement relative to a second implement rotational axis substantially perpendicular to the first implement rotational axis. A sensor may be configured to determine an actual pose of the implement and generate an actual pose signal, the actual pose signal including a first actual angle component relative to the first implement rotational axis and a second actual angle component relative to the second implement rotational axis. The machine may further include a controller operably coupled to the first actuator, second actuator, and sensor, the controller being configured to determine a desired implement pose having a first desired angle component relative to the first implement rotational axis and a second desired angle component relative to the second implement rotational axis, determine a first axis error indicative of a difference between the first desired angle component and the first actual angle component, and determine a second axis error indicative of a difference between the second desired angle component and the second actual angle component. The controller may further be configured to automatically operate the first actuator in response to the first axis error, and automatically operate the second actuator in response to the second axis error.

### BRIEF DESCRIPTION OF THE DRAWINGS

FIG. 1 is a side elevation view of an exemplary machine;

FIG. 2 is a schematic illustration of an exemplary hydraulic control system that may be used with the machine of FIG. 1;

FIG. 3 is a end elevation view of the machine of FIG. 1; and

FIG. 4 is a flowchart illustrating an exemplary method of operating the hydraulic control system of FIGS. 1-3 to automatically place an implement in a desired pose.

### DETAILED DESCRIPTION

Embodiments of systems and methods for controlling an orientation of an implement provided on a machine are provided. These embodiments automatically control the position and orientation of the implement to permit certain tasks or portions of tasks to be carried out, thereby eliminating user error and inefficiency. The position and orientation of an object (such as the implement) is referred to herein as a “pose.”

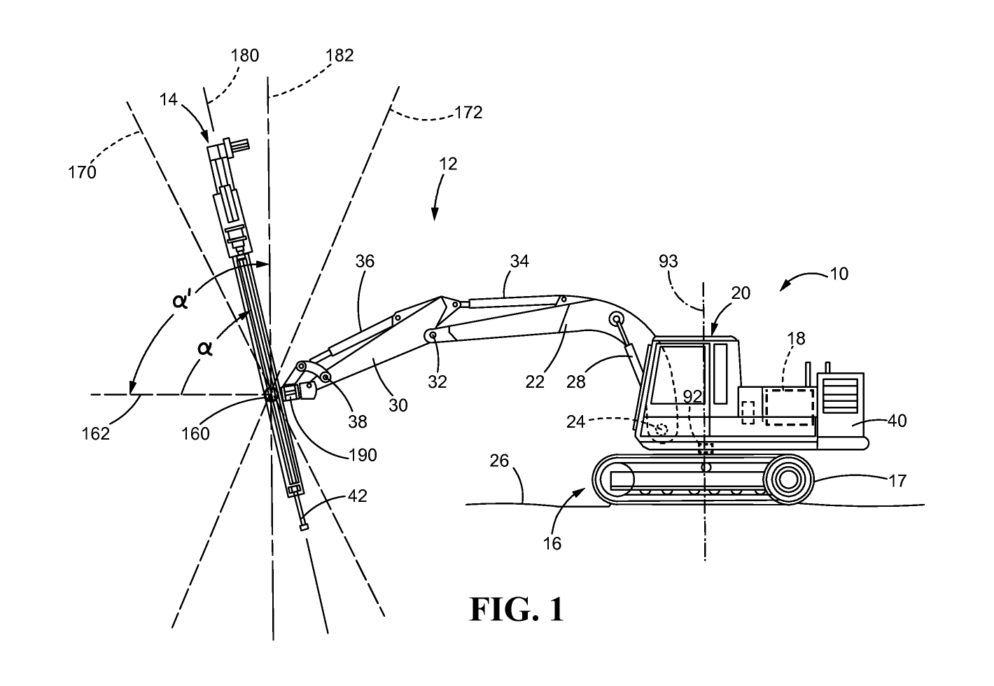

FIG. 1 illustrates an exemplary machine 10 having multiple systems and components that cooperate to accomplish a task. Machine 10 may embody a fixed or mobile machine that performs some type of operation associated with an industry such as mining, construction, farming, transportation, or any other industry known in the art. For example, machine 10 may be an earth moving machine such as an excavator (as shown), a backhoe, a track-type tractor, a loader, a motor grader, or any other earth moving machine. Machine 10 may include an implement system 12 configured to move an implement 14, a drive system 16 for propelling ground engaging units 17, a power source 18 that provides power to implement system 12 and drive system 16, and an operator station 20 for operator control of implement system 12 and drive system 16.

Power source 18 may embody an engine such as, for example, a diesel engine, a gasoline engine, a gaseous fuel-powered engine or any other type of combustion engine known in the art. It is contemplated that power source 18 may alternatively embody a non-combustion source of power such as a fuel cell, a power storage device, or another source known in the art. Power source 18 may produce a mechanical or electrical power output that may then be converted to hydraulic power for moving implement system 12.

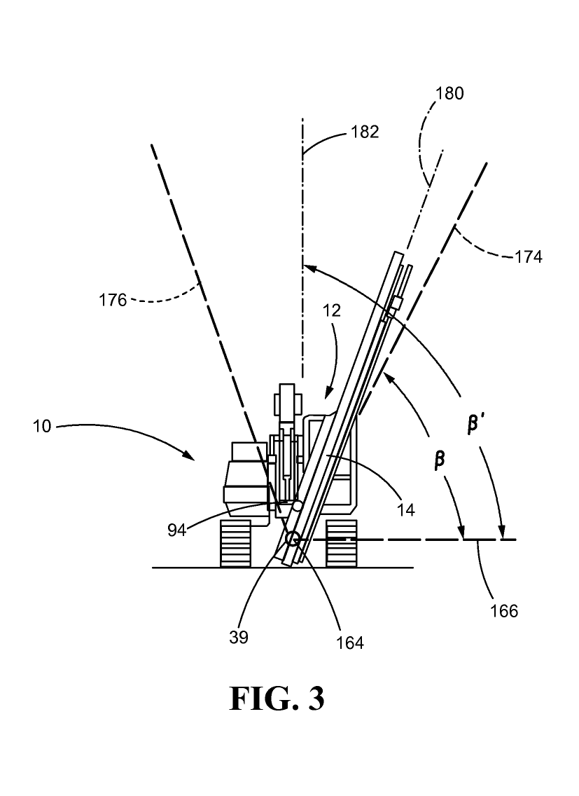

Implement system 12 may include a linkage structure acted on by fluid actuators to move implement 14. The linkage structure of implement system 12 may be complex, for example, including three or more degrees of freedom. Specifically, implement system 12 may include a boom 22 vertically pivotal about an axis 24 relative to a work surface 26 by an actuator, such as a single, double-acting, hydraulic cylinder 28. Implement system 12 may also include a stick member 30 vertically pivotal about an axis 32 by an actuator, such as a single, double-acting, hydraulic cylinder 34. Implement system 12 may further include an actuator, such as a single, double-acting, hydraulic cylinder 36, operatively connected to implement 14 to pivot implement 14 about a substantially horizontal axis 38. The hydraulic cylinder 36 may be operatively coupled to an implement linkage 37. Boom 22 may be pivotally connected at one end to a frame 40 of machine 10. Stick member 30 may pivotally connect to an opposing end of boom 22 and to implement 14 by way of axes 32 and 38. Movement of boom 22 about axis 24, stick member 30 about axis 32, and implement 14 about axis 38 may define three degrees of freedom for implement system 12. The implement system 12 may further include a fourth degree of freedom such as lateral swing movement of implement system 12, which may be generated by a swing motor 92 that rotates the operator station 20 about a vertically extending axis 93. The implement 14 may further include a fifth degree of freedom such as tilt angle rotation, which may be generated by an actuator, such as a single, double-acting, implement tilt cylinder 94, operatively coupled to implement 14 to pivot implement 14 about a substantially horizontal tilt axis 39, as best shown in FIG. 3.

Each of hydraulic cylinders 28, 34, 36, and 94 may include a tube and a piston assembly (not shown) arranged to form two separated pressure chambers. The pressure chambers may be selectively supplied with pressurized fluid and drained of the pressurized fluid to cause the piston assembly to displace within the tube, thereby changing the effective length of hydraulic cylinders 28, 34, 36, and 94. The flow rate of fluid into and out of the pressure chambers may relate to a velocity of hydraulic cylinders 28, 34, 36, and 94 while a pressure differential between the two pressure chambers may relate to a force imparted by hydraulic cylinders 28, 34, 36, and 94 on the associated linkage members. The expansion and retraction of hydraulic cylinders 28, 34, 36, and 94 may function to assist in moving implement 14.

Implement 14 may include any device used to perform a particular task such as, for example, a drill, a bucket, an auger, a blade, a shovel, a ripper, a broom, a snow blower, a cutting device, a grasping device, or any other task-performing device known in the art. Numerous different implements 14 may be attachable to machine 10 and controllable via operator station 20. Each implement 14 may be configured to perform a specialized function. For example, machine 10 may include a hydraulic drill 42 attached to implement system 12.

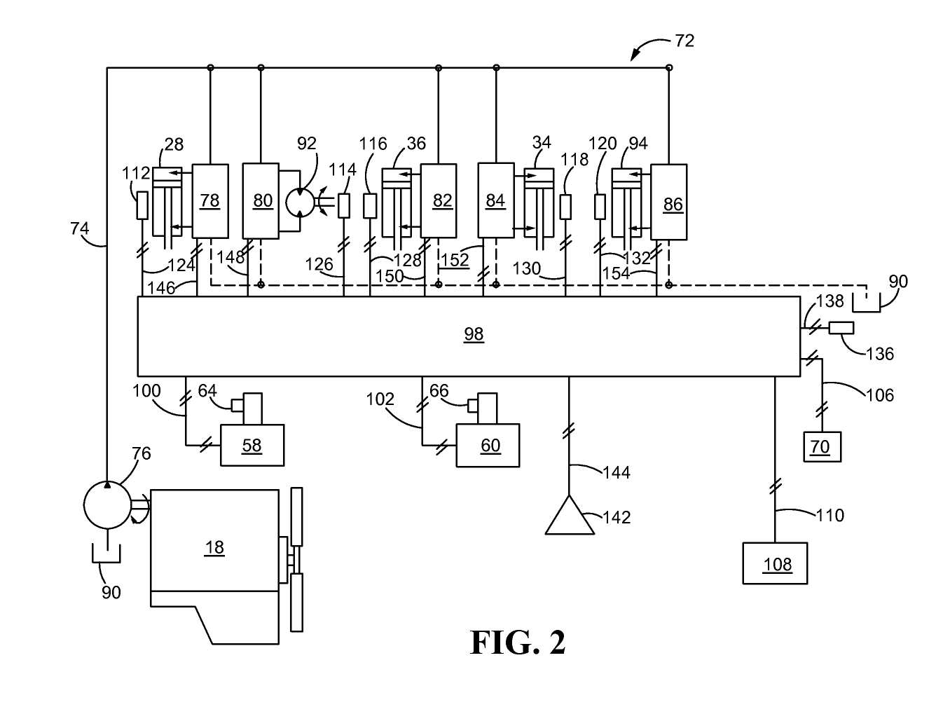

Operator station 20 may receive input from a machine operator indicative of a desired implement movement. Specifically, operator station 20 may include one or more operator interface devices embodied as single or multi-axis joysticks located proximal an operator seat. The operator interface devices may include, among other things, a left hand joystick 58 and a right hand joystick 60. Operator interface devices 58 and 60 may be proportional-type controllers configured to position and/or orient implement 14 by varying fluid pressure to hydraulic cylinders 28, 34, 36, and 94. For example, operator interface devices 58 and 60 may impart movement of implement 14, by moving operator interface devices 58 and 60 to the left, right, forward, backward, and/or by twisting. Additionally, each operator interface device 58 and 60 may include one or more triggers 64 and 66 (see FIG. 2), respectively, for receiving operator input. It is contemplated that different operator interface devices may alternatively or additionally be included within operator station 20 such as, for example, wheels, knobs, push-pull devices, switches, pedals, and other operator interface devices known in the art. It is further contemplated that a graphical user interface 70 may be located within operator station 20 to receive operator input. Graphical user interface 70 may include various input interfaces including, for example, drop-down menus.

As illustrated in FIG. 2, machine 10 may include a hydraulic control system 72 having a plurality of fluid components that cooperate to move implement 14. In particular, hydraulic control system 72 may include a supply line 74 configured to receive a first stream of pressurized fluid from a source 76. A boom control valve 78, a swing control valve 80, an implement linkage control valve 82, a stick control valve 84, and an implement tilt control valve 86 may be connected to receive pressurized fluid in parallel from supply line 74. Each of these control valves 78-86 may be controlled by a predetermined movement of one of the operator interface devices 58, 60 or by actuation of one of the triggers 64, 66.

Source 76 may draw fluid from one or more tanks 90 and pressurize the fluid to predetermined levels. Specifically, source 76 may embody a pumping mechanism such as a variable displacement pump, a fixed displacement pump, or any other source known in the art. For example, source 76 may include a single pump that supplies pressurized actuator and pilot fluid directed to hydraulic cylinders 28, 34, 36, and 94. Source 76 may be drivably connected to power source 18 of machine 10 by, for example, a countershaft, a belt (not shown), an electrical circuit (not shown), or in any other suitable manner. Alternatively, source 76 may be indirectly connected to power source 18 via a torque converter, a reduction gear box, or in any other suitable manner. Further, source 76 may alternatively include separate pumping mechanisms to independently supply actuator and/or pilot fluid to hydraulic cylinders 28, 34, 36, and 94, if desired.

Tank 90 may constitute a reservoir configured to hold a supply of fluid. The fluid may include, for example, a dedicated hydraulic oil, an engine lubrication oil, a transmission lubrication oil, or any other fluid known in the art. One or more hydraulic systems within machine 10 may draw fluid from and return fluid to tank 90. It is contemplated that hydraulic control system 72 may be connected to multiple separate fluid tanks or to a single tank.

Each of boom, swing, implement, stick, and tilt angle control valves 78-86 may regulate the motion of their related fluid actuators. Specifically, boom control valve 78 may have valve elements movable to control the motion of hydraulic cylinder 28 associated with boom 22; swing control valve 80 may have valve elements movable to control a swing motor 92 associated with providing rotational movement of the operator station 20; implement linkage control valve 82 may have valve elements movable to control the motion of hydraulic cylinder 36 associated with drill 42; stick control valve 84 may have valve elements movable to control the motion of hydraulic cylinder 34 associated with stick member 30; and implement tilt control valve 86 may have valve elements movable to control the motion of the hydraulic cylinder associated with the implement tilt cylinder 94. It is contemplated that a pair of double acting cylinders may be used as an alternative to swing motor 92 to provide rotational movement of implement system 12, if desired. Similarly contemplated, a motor may be used as an alternative to each hydraulic cylinder 28, 34, 36, and 94 to provide movement to implement system 12.

One or more sensors may be associated with swing motor 92 and hydraulic cylinders 28, 34, 36, and 94. More specifically, machine 10 may include a plurality of sensors for monitoring the position and/or velocity of implement system 12. For example, machine 10 may include a boom sensor 112, a swing sensor 114, an implement linkage sensor 116, a stick sensor 118, and implement tilt sensor 120. Sensors 112-120 may be any type of sensors capable of monitoring and transmitting position or velocity information of machine 10 and/or implement 14 to a controller 98. For example, sensors 112-120 may be in-cylinder displacement sensors when cylinder actuators are implemented. Alternatively, sensors 112-120 may employ joint angle sensors, for example, when motor actuators are implemented. It is also contemplated that sensors 112-120 may be sensors capable of determining velocity of an element. For example, sensors 112-120 may be angular velocity sensors. Furthermore, an additional sensor may be associated with determining a relative position of machine 10. For example, machine 10 may include a level sensor 136.

Machine 10 may include controller 98 for receiving information from various input devices and responsively transmitting output commands to control valves 78-86 of hydraulic control system 72. Controller 98 may receive signals from operator interface devices 58 and 60 via communication lines 100 and 102, respectively. Further, controller 98 may receive operator input from graphical user interface 70 via communication line 106. Controller 98 may also access a memory storage device 108 via a communication line 110 to retrieve and/or store operational control data contained in memory storage device 108. Controller 98 may further receive information from one or more sensors. For example, controller 98 may receive information from boom sensor 112 via a communication line 124, from swing sensor 114 via a communication line 126, from implement linkage sensor 116 via a communication line 128, from stick sensor 118 via a communication line 130, and from implement tilt sensor 120 via communication line 132. Additionally, controller 98 may also receive input from level sensor 136 via a communication line 138. Still further, controller 98 may receive input or data delivered wirelessly to receiver 142, which may communicate with the controller 98 via communication line 144. Output commands from the controller 98 may be delivered in any suitable manner, such as in the form of control signals, to control valves 78-86 via communication lines 146, 148, 150, 152, and 154, respectively.

Implement system 12 is operable to place implement 14 in a pose that can be defined relative to reference axes. More specifically, as best shown in FIGS. 1 and 3, the implement 14 may have an actual implement pose that includes a first actual angle component α and a second actual angle component β. The first actual angle component a may be measured about a first implement rotational axis 160. For example, the angle α may be determined relative to a first reference line 162 extending through the first implement rotational axis 160 (FIG. 1). The second actual angle component β may be measured about a second implement rotational axis 164, such as with reference to a second reference line 166 extending through the second implement rotational axis 164 (FIG. 3). The second implement rotational axis 164 may be substantially perpendicular to the first implement rotational axis 160. When taken together, the first and second actual angle components α and β define a specific pose at which the implement 14 is oriented.

### INDUSTRIAL APPLICABILITY

The disclosed control system may be applicable to any machine that includes operator control of a work tool by way of a plurality of different actuators. The disclosed control system may increase operational efficiency by selectively implementing automatic implement pose control such that overall control of the implement is simplified for the operator. For purposes of explanation, only operational control of implement system 12 with reference to drill 42 will be described in detail.

An operator may be executing a task that requires the implement 14 to be oriented in a desired pose. While it may be possible for the operator to manually manipulate the operator interface devices 58, 60, 64, 66 as needed to complete the task, efficiency may be increased by selectively overriding the manual control and instead automatically placing the implement 14 in the desired pose.

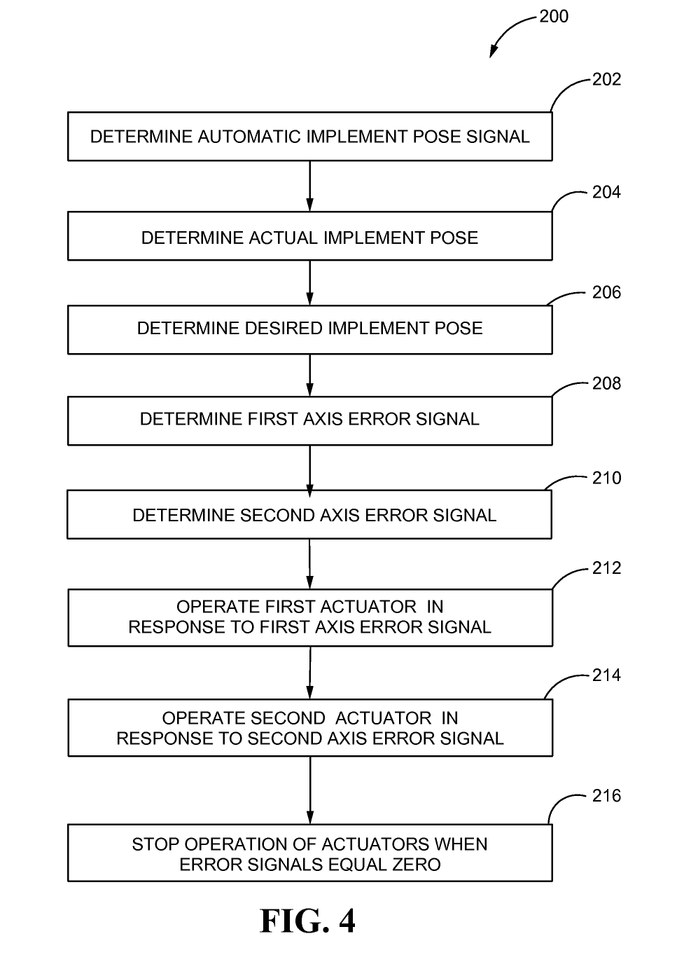

A method 200 of automatically placing the implement 14 in a desired pose is illustrated by the flowchart of FIG. 4. The method 200 may be initiated at block 202, where the controller 98 may be configured to determine an automatic implement pose signal that indicates that an automatic pose operator interface has been actuated. The automatic implement pose signal may be generated by a predetermined movement of one of the joysticks 58, 60 or by actuation of one of the triggers 64, 66. In some embodiments, the automatic pose operator interface is the right hand joystick trigger 66.

In some embodiments, the method 200 may be initiated only when the actual implement pose is within angle limits relative to the desired implement pose. For example, positive and negative first axis boundaries 170, 172 (FIG. 1), and positive and negative second axis boundaries 174, 176 (FIG. 3), may be defined and stored by the controller 98. The method 200 may optionally require the operator to manually place the implement in an actual implement pose that falls within the sets of boundaries 170, 172, 174, 176 before permitting automatic pose control of the implement 14.

At block 204, the controller 98 may be configured to determine an actual implement pose that indicates the current position and orientation of the implement 14. In the illustrated embodiment, the actual implement pose is defined by first and second actual angle components. As noted above, the first actual angle component a may be measured about a first implement rotational axis 160 (FIG. 1), while the second actual angle component β may be measured about a second implement rotational axis 164 (FIG. 3). The first and second implement rotational axes 160, 164 may be perpendicular to one another so that an actual pose of the implement may be determined based on the angle components.

In some embodiments, one or more implement specific sensors may be provided to directly determine the actual pose (illustrated by actual pose axis 180) of the implement 14 with respect to a reference point. A dual axis slope sensor 190, for example, may be operably coupled to the implement 14 which may provide implement position data in two planes relative to the direction of the force of gravity. Accordingly, the dual axis slope sensor 190 may be configured to directly provide the first and second actual angle components α and β.

At block 206, the controller 98 may be configured to determine a desired implement pose that indicates the desired position and orientation of the implement 14. The desired implement pose (illustrated by desired pose axis 182) may be defined relative to the same rotational axes 160, 164 used to define the actual implement pose. That is, the desired implement pose may include a first desired angle component α′ that is measured about the first implement rotational axis 160 relative to the first reference line 162 (FIG. 1). The desired implement pose may also include a second desired angle component β′ that is measured about the second implement rotational axis 164 relative to the second reference line 166 (FIG. 3). Thus, the first and second desired angle components α′ and β′ define the desired implement pose. In some embodiments, the desired implement pose may be a plumb pose, in which the implement 14 is oriented so that it is substantially vertical and aligned with the direction of the force of gravity. In other embodiments, the desired implement pose may be any pose that may be manually or automatically selected by the operator to maintain the drill 42 at a desired angle relative to a reference point, for example, relative to work surface 26.

At blocks 208 and 210, the controller 98 may be configured to determine first and second axis error. The first axis error is indicative of a difference between the first desired angle component and the first actual angle component, while the second axis error is indicative of a difference between the second desired angle component and the second actual angle component. The first and second axis errors may be identified using any suitable expression that conveys the direction and magnitude of the difference between the actual and desired poses.

At blocks 212 and 214, the controller 98 may be configured to operate at least first and second actuators, such as one or more of hydraulic cylinders 28, 34, 36, 94, in response to the first and second axis errors. In the illustrated embodiment, for example, the controller 98 may be configured to operate the implement linkage cylinder 36 in a direction that reduces the first axis error and to operate the implement tilt cylinder 94 in a direction that reduces the second axis error. More specifically, the controller 98 may operate the implement linkage control valve 82 and implement tilt control valve 86 so that the associated actuators are moved in the desired directions to reduce the first and second axis errors.

At block 216, the controller 98 may be programmed to operate the actuators until the errors are reduced to substantially zero or within an acceptable range near zero. When the error is reduced to an acceptable level, the implement will be at the desired implement pose. At this point the operator may release the automatic pose operator interface to exit automatic pose control operation. Alternatively, the operator may continue to activate the automatic pose operator interface to maintain the implement in the desired implement pose while additional functions are performed. For example, the boom or stick cylinders 28, 34 may be operated to raise or lower the implement system 12, such as during a drilling operation. By continuing to activate the automatic pose operator interface, the controller 98 will maintain the desired implement pose during movement of the boom 22 and/or stick member 30.

It will be appreciated that the foregoing description provides examples of the disclosed assembly and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A method of automatically controlling a pose of an implement provided on a machine, the machine including a first actuator configured to rotate the implement about a first implement rotational axis and a second actuator configure to rotate the implement about a second implement rotational axis substantially perpendicular to the first implement rotational axis, the method comprising:
determining an actual implement pose having a first actual angle component relative to the first implement rotational axis and a second actual angle component relative to the second implement rotational axis;
determining a desired implement pose having a first desired angle component relative to the first implement rotational axis and a second desired angle component relative to the second implement rotational axis;
determining a first axis error indicative of a difference between the first desired angle component and the first actual angle component;
determining a second axis error indicative of a difference between the second desired angle component and the second actual angle component;
automatically operating the first actuator in response to the first axis error; and
automatically operating the second actuator in response to the second axis error.

2. The method of claim 1, in which the desired implement pose comprises a plumb pose.

3. The method of claim 2, in which a sensor is provided for determining the first and second angle components of the actual implement pose.

4. The method of claim 3, in which the sensor comprises a dual axis slope sensor configured to measure the first and second angle components relative to a direction of gravity force.

5. The method of claim 1, in which:
the machine comprises an excavator having an arm;
the implement comprises a drill coupled to the arm with a linkage;
the first actuator comprises a linkage cylinder operably coupled to the linkage; and
the second actuator comprises a drill tilt cylinder.

6. The method of claim 1, further comprising, prior to automatically operating the first and second actuators, determining an automatic implement angle signal indicative of actuation of an automatic angle operator interface provided on the machine.

7. The method of claim 6, in which the automatic angle operator interface comprises a joystick trigger.

8. The method of claim 1, in which automatically operating the first actuator in response to the first axis error comprises operating the first actuator until the first axis error is reduced to substantially 0, and in which automatically operating the second actuator in response to the second axis error comprises operating the second actuator until the second axis error is reduced to substantially 0.

9. A system for automatically controlling a pose of an implement provided on a machine, the system comprising:
a first actuator operably coupled to the implement and configured to rotate the implement relative to a first implement rotational axis;
a second actuator operably coupled to the implement and configured to rotate the implement relative to a second implement rotational axis substantially perpendicular to the first implement rotational axis;
a sensor configured to determine an actual pose of the implement and generate an actual pose signal, the actual pose signal including a first actual angle component relative to the first implement rotational axis and a second actual angle component relative to the second implement rotational axis; and
a controller operably coupled to the first actuator, second actuator, and sensor, the controller being configured to:
determine a desired implement pose having a first desired angle component relative to the first implement rotational axis and a second desired angle component relative to the second implement rotational axis;
determine a first axis error indicative of a difference between the first desired angle component and the first actual angle component;
determine a second axis error indicative of a difference between the second desired angle component and the second actual angle component;
automatically operate the first actuator in response to the first axis error; and
automatically operate the second actuator in response to the second axis error.

10. The system of claim 9, in which the desired implement pose comprises a plumb pose.

11. The system of claim 10, in which the sensor comprises a dual axis slope sensor configured to measure the first and second actual angle components relative to a direction of gravity force.

12. The system of claim 9, in which:
the machine comprises an excavator having an arm;
the implement comprises a drill coupled to the arm with a linkage;
the first actuator comprises a linkage cylinder operably coupled to the linkage; and
the second actuator comprises a drill tilt cylinder.

13. The system of claim 12, in which the arm comprises a stick.

14. The system of claim 9, in which the controller is further configured, prior to automatically operating the first and second actuators, to determine an automatic implement angle signal indicative of actuation of an automatic angle operator interface provided on the machine.

15. The system of claim 14, in which the automatic angle operator interface comprises a joystick trigger.

16. The system of claim 9, in which the controller is configured to:
automatically operate the first actuator in response to the first axis error by moving the first actuator until the first axis error is reduced to substantially 0; and
automatically operate the second actuator in response to the second axis error by moving the second actuator until the second axis error is reduced to substantially 0.

17. A machine comprising:
a frame;
ground-engaging members coupled to the frame;
an operator interface supported by the frame;
an arm pivotably coupled to the frame;
an implement pivotably coupled to the arm by a linkage;
a first actuator operably coupled to the linkage and configured to rotate the implement relative to a first implement rotational axis;
a second actuator operably coupled to the implement and configured to rotate the implement relative to a second implement rotational axis substantially perpendicular to the first implement rotational axis;
a sensor configured to determine an actual pose of the implement and generate an actual pose signal, the actual pose signal including a first actual angle component relative to the first implement rotational axis and a second actual angle component relative to the second implement rotational axis; and
a controller operably coupled to the first actuator, second actuator, and sensor, the controller being configured to:
determine a desired implement pose having a first desired angle component relative to the first implement rotational axis and a second desired angle component relative to the second implement rotational axis;
determine a first axis error indicative of a difference between the first desired angle component and the first actual angle component;
determine a second axis error indicative of a difference between the second desired angle component and the second actual angle component;
automatically operate the first actuator in response to the first axis error; and
automatically operate the second actuator in response to the second axis error.

18. The machine of claim 17, in which the desired implement pose comprises a plumb pose, and in which the sensor comprises a dual axis slope sensor configured to measure the first and second actual angle components relative to a direction of gravity force.

19. The machine of claim 17, in which:
the machine comprises an excavator and the arm comprises a stick;
the implement comprises a drill;
the first actuator comprises a linkage cylinder; and
the second actuator comprises a drill tilt cylinder.

20. The machine of claim 17, in which the controller is configured to:
automatically operate the first actuator in response to the first axis error by moving the first actuator until the first axis error is reduced to substantially 0; and
automatically operate the second actuator in response to the second axis error by moving the second actuator until the second axis error is reduced to substantially 0.
